(19) United States
(12) Patent Application Publication
(10) Pub. No.: US 2010/0121687 A1
(43) Pub. Date: May 13, 2010

(54) PROFITABILITY PROJECTION SYSTEM

(76) Inventor: Sean Cunningham, Seattle, WA (US)

Correspondence Address: Ruttler IP Law PLLC;One Union Square, 600 University Street, Suite 1919, Seattle, WA, 98101, US

(21) Appl. No.: 12/483,775

(22) Filed: Jun. 12, 2009

Related U.S. Application Data
(60) Provisional application No. 61/113,113, filed on Nov. 10, 2008.

(51) Int. Cl. G06Q 10/00

(52) U.S. Cl. 705/11; 705/30; 705/32; 705/7

(57) ABSTRACT

This invention relates generally to software, and more specifically, to a profitability projection system. In one embodiment, the invention includes an application server, the application server including a profitability component. In a further embodiment, the profitability component includes a margin rate component configured to perform the steps of determining a margin rate of at least one person using a bill rate for the at least one person and a cost rate for the at least one person, the cost rate for the at least one person being a function of a quantity of hours and/or the bill rate. In yet a further embodiment, the profitability component includes a profitability projection component configured to perform the steps of projecting profitability of the at least one person using project parameters received via user input, the received project parameters usable to determine the margin rate of the at least one person using the margin rate component. In one particular embodiment, the received project parameters comprise the bill rate, the at least one person, and the quantity of hours.

### PRIORITY CLAIM

This application claims the benefit of U.S. provisional patent application Ser. No. 61/113,113 filed Nov. 10, 2008 (our ref. LGIC-1-1001). The foregoing application is hereby incorporated by reference in its entirety as if fully set forth herein.

### FIELD OF THE INVENTION

This invention relates generally to software, and more specifically, to a profitability projection system.

### SUMMARY

This invention relates generally to software, and more specifically, to a profitability projection system. In one embodiment, the invention includes an application server, the application server including a profitability component. In a further embodiment, the profitability component includes a margin rate component configured to perform the steps of determining a margin rate of at least one person using a bill rate for the at least one person and a cost rate for the at least one person, the cost rate for the at least one person being a function of a quantity of hours and/or the bill rate. In yet a further embodiment, the profitability component includes a profitability projection component configured to perform the steps of projecting profitability of the at least one person using project parameters received via user input, the received project parameters usable to determine the margin rate of the at least one person using the margin rate component. In one particular embodiment, the received project parameters comprise the bill rate, the at least one person, and the quantity of hours. The present invention may be applied in any field including services, retail sales, manufacturing, distribution, and any other similar field.

### BRIEF DESCRIPTION OF THE DRAWINGS

Embodiments of the present invention are described in detail below with reference to the following drawings:

FIG. 1 is a system diagram, in accordance with an embodiment of the invention;

FIG. 2 is a method block diagram, in accordance with an embodiment of the invention;

FIG. 3 is a method block diagram, in accordance with an embodiment of the invention;

FIG. 4 is a method block diagram, in accordance with an embodiment of the invention;

FIG. 5 is a system diagram, in accordance with an embodiment of the invention; and

APPENDIX A contains illustrations of various example implementations of the system, in accordance with embodiments of the invention.

### DETAILED DESCRIPTION

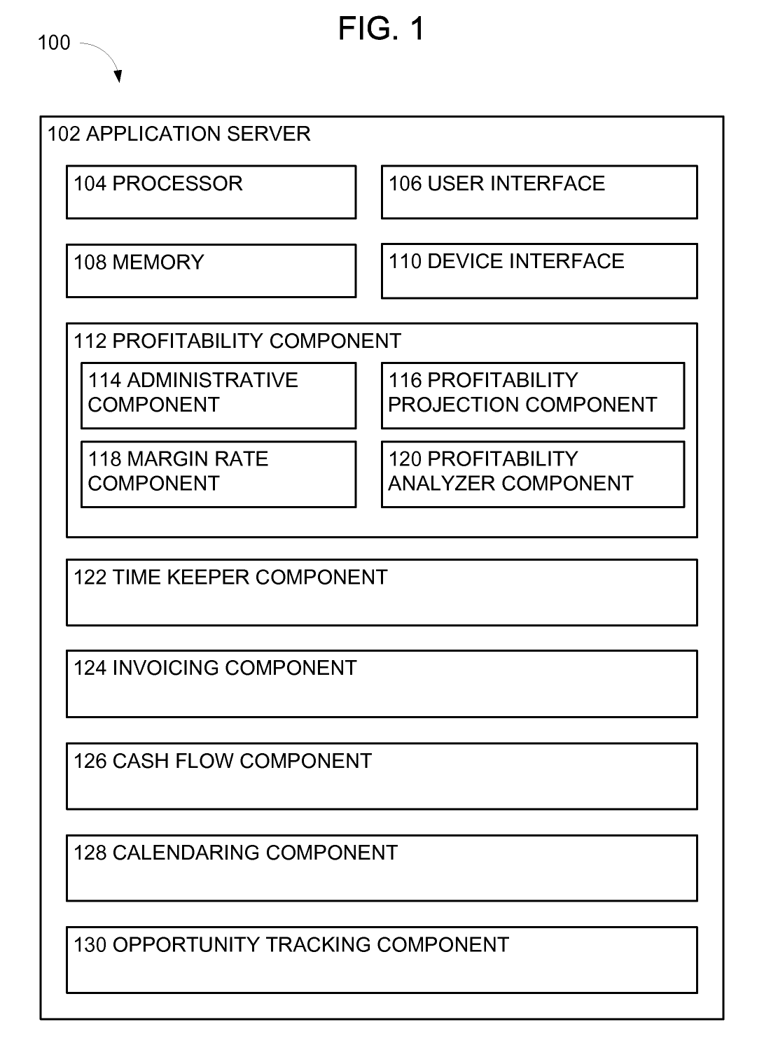

This invention relates generally to software, and more specifically, to a profitability projection system. Specific details of certain embodiments of the invention are set forth in the following description and in FIGS. 1-5 and APPENDIX A to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a system diagram, in accordance with an embodiment of the invention. In some embodiments, system 100 may include one or more processors 104, one or more user interfaces 106, one or more memory 108, one or more device interfaces 110, one or more profitability components 112, one or more time keeper components 122, one or more invoicing components 124, one or more cash flow components 126, one or more calendaring components 128, and/or one or more opportunity tracking components 130. In some embodiments, the one or more profitability components 112 may include one or more administrative components 114, one or more profitability projection components 116, one or more margin rate components 118, and/or one or more profitability analyzer components 120. In some embodiments, the one or more profitability projection components 116 may allow real-time profitability projections for any present or future work based upon actual margin rates that are determined based upon parameters for the work. In some embodiments, the one or more profitability analyzer components 120 may allow real-time profitability analysis for any present or past work based upon actual margin rates that are determined based upon existing performance data. In some embodiments, the one or more administrative components may allow 114 may allow administration of persons, pay rates, overheads, formulas, and any other administrative feature discussed or referenced herein. In some embodiments, the one or more time keeper components 122 may allow tracking of time for performed work. In some embodiments, the one or more invoicing components 124 may allow for billing of time for performed work. In some embodiments, the one or more cash flow components 126 may allow for analyzing cash flow for payments received and paid. In some embodiments, the one or more calendaring components 128 may allow for tracking of availability of persons for performing work. In some embodiments, the one or more opportunity tracking components 130 allow for tracking of work opportunities such as with pipeline and contact management. Additional details for certain components are described more fully herein.

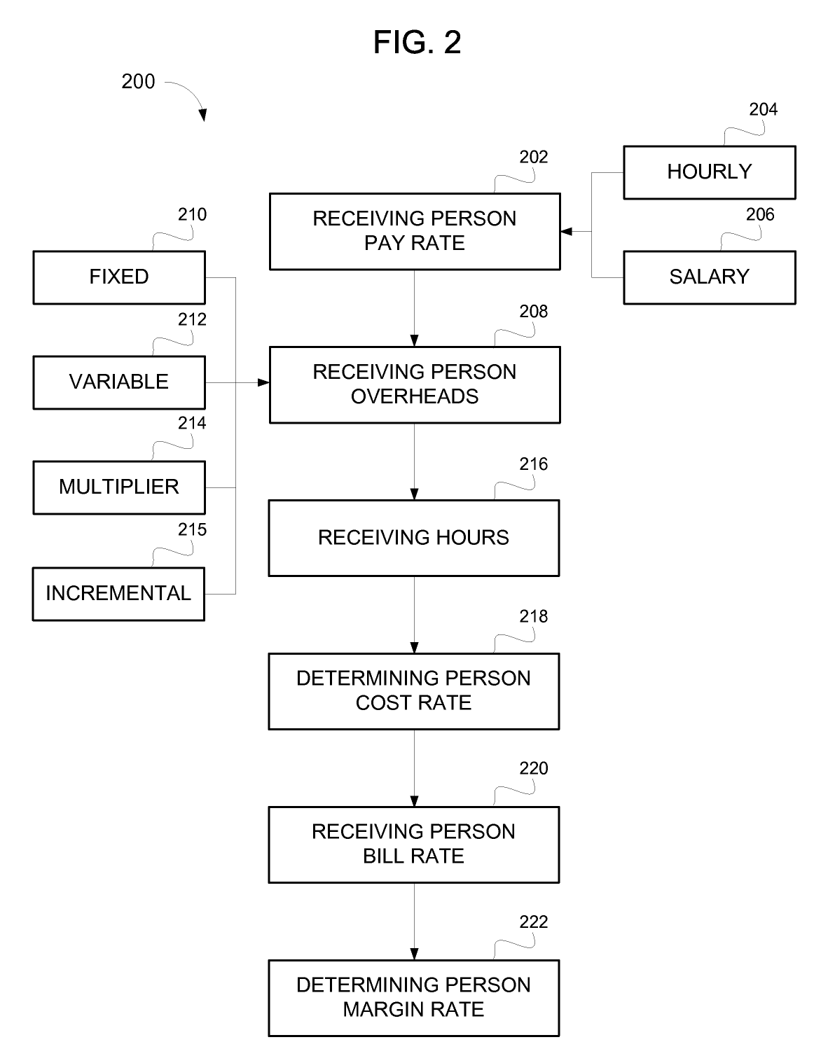

FIG. 2 is a method block diagram, in accordance with an embodiment of the invention. In some embodiments, method 200 may be implemented by the one or more margin rate components 118. In some embodiments, method 200 may include receiving one or more person pay rates at 202, receiving one or more person overheads at 208, receiving one or more hours at 216, determining one or more person cost rates at 218, receiving one or more person bill rates at 220, and/or determining one or more person margin rates at 222. In some embodiments, the receiving one or more person pay rates at 202 may include receiving one or more hourly rates at 204 and/or receiving one or more salaries at 206. In some embodiments, the receiving one or more person overheads at 206 may include receiving one or more fixed overheads at 210, receiving one or more variable overheads at 212, receiving one or more multiplier overheads at 214, and/or receiving one or more incremental overheads at 215. As described further below, method 200 provides for precise margin rate determinations for one or more persons based upon cost rates and bill rates that are determined based upon data such as pay rates, overheads, and hours. Such data may be provided based upon anticipated future needs or from performance data from past work.

In some embodiments, method 200 may include determining a margin rate of at least one person using a bill rate for the at least one person and a cost rate for the at least one person, the cost rate for the at least one person being a function of a quantity of hours and/or the bill rate. For example, method 200 may include receiving a pay rate of 12,000/month at 202, receiving hours of 160 hours/month at 216, determining a cost rate of $75/hour by dividing the pay rate by the hours at 218, receiving a bill rate of $150/hour at 220, and determining a margin rate of $75/hour by subtracting the cost rate from the bill rate at 222.

In some embodiments, method 200 may include wherein the cost rate for the at least one person is determined by receiving a pay rate for the at least one person and at least one overhead for the at least one person and the quantity of hours, wherein the pay rate for the at least one person or the at least one overhead for the at least one person is a function of the quantity of hours and/or the bill rate. For example, method 200 may include receiving a pay rate of $50/hour at 202, receiving an overhead of 2.5% tax on revenue at 208, receiving hours of 160/month at 216, receiving a bill rate of $150/hour at 220, determining a cost rate of $53.75 by multiplying the tax on revenue by the bill rate and adding this amount to the pay rate at 218, and determining a margin rate of $96.25 by subtracting the cost rate from the bill rate at 222.

In some embodiments, method 200 may include wherein the pay rate for the at least one person and the at least one overhead for the at least one person are received from an administrative component. For example, in some embodiments, the pay rate for the at least one person and the at least one overhead for the at least one person may be received from the administrative component 114. The administrative component 114 may provide a record of persons, their employment types (e.g. W2 salary, W2, hourly, 1099 hourly), their pay rates, and information regarding overheads. Such data may be modified, which would then affect future margin rate determinations.

In some embodiments, method 200 may include wherein the at least one overhead for the at least one person comprises at least one non-commission, at least one sales commission, or at least one recruiter commission. In some embodiments, the sales commission may be compensation to a sales person for securing work for a person with a client and the recruiter commission may be compensation to a recruiter for securing the person. For example, method 200 may include receiving a pay rate of $50/hour at 202, receiving an overhead of 2.5% tax on revenue at 208, receiving an overhead of 3% commission on revenue at 208, receiving hours of 160/month at 216, receiving a bill rate of $150/hour at 220, determining a cost rate of $58.25 by multiplying the tax on revenue by the bill rate and multiplying the commission on revenue by the bill rate and adding both to the pay rate at 218, and determining a margin rate of $91.75 by subtracting the cost rate from the bill rate at 222. Additionally, method 200 may include receiving a pay rate of $50/hour at 202, receiving an overhead of 2.5% tax on revenue at 208, receiving an overhead of 3% commission on margin at 208, receiving hours of 160/month at 216, receiving a bill rate of $150/hour at 220, determining a cost rate of $56.64 by multiplying the tax on revenue by the bill rate, adding this amount to the pay rate, multiplying the commission on margin by the difference between the pay rate with the tax on revenue amount and the bill rate, and adding this amount to the pay rate and the tax on revenue amount at 218, and determining a margin rate of $93.36 by subtracting the cost rate from the bill rate at 222.

In some embodiments, method 200 may include wherein the at least one overhead for the at least one person is selected from a plurality of overheads according to the at least one person. In some embodiments, each of the plurality of overheads may include a first effective date, a last effective date, and/or a person type for which the overhead applies and method 200 may include receiving one or more of the overheads at 208 automatically based upon a date and a person. For example, in some embodiments, method 200 may include receiving an overhead for B&O Tax, which is effective after May 26, 2001 without an end date and is applicable to W2 hourly, W2 salary, and 1099 persons, automatically at 208 for margin rate determinations of a W2 salary person performing work during the year 2009.

In some embodiments, method 200 may include wherein the at least one overhead for the at least one person is fixed, variable, a multiplier, or incremental. In some embodiments, a fixed overhead is an overhead that remains constant independent of fluctuations in pay rates, hours, and/or bill rates. For example, in some embodiments, method 200 may include receiving a pay rate of $50/hr at 202, receiving a fixed overhead of $5.40/hour at 208, and determining a cost rate of $55.40/hr by adding the fixed overhead to the pay rate at 218. In some embodiments, a variable overhead is an overhead that varies depending upon a number of hours. For example, in some embodiments, method 200 may include receiving a pay rate of $50/hr at 202, receiving hours of 168 hours/month at 216, receiving a variable health insurance overhead of $450/month at 208, and determining a cost rate of $52.67/hr by dividing the variable overhead by the hours and adding this amount to the pay rate at 218. In some embodiments, a multiplier overhead is an overhead that is a percentage of a bill rate or a pay rate. For example, in some embodiments, method 200 may include receiving a pay rate of $50/hr at 202, receiving a bill rate multiplier overhead of 4.5% at 208, receiving a bill rate of $120 at 220, and determining a cost rate of $55.40/hr by multiplying the bill rate multiplier by the bill rate and adding this amount to the pay rate at 218. For example, in some embodiments, method 200 may include receiving a pay rate of $50/hr at 202, receiving a pay rate multiplier overhead of 4.5% at 208, and determining a cost rate of $52.25/hr by multiplying the pay rate multiplier by the pay rate and adding this amount to the pay rate at 218. In some embodiments, an incremental overhead is an overhead that occurs for a given number of hours. For example, in some embodiments, method 200 may include receiving a pay rate of $50/hr at 202, receiving an incremental overhead of $500 for every 500 hours at 208, receiving hours of 750 at 216, and determining a cost rate of $50.67/hr by dividing one unit of incremental overheads by the hours and adding this amount to the pay rate at 218.

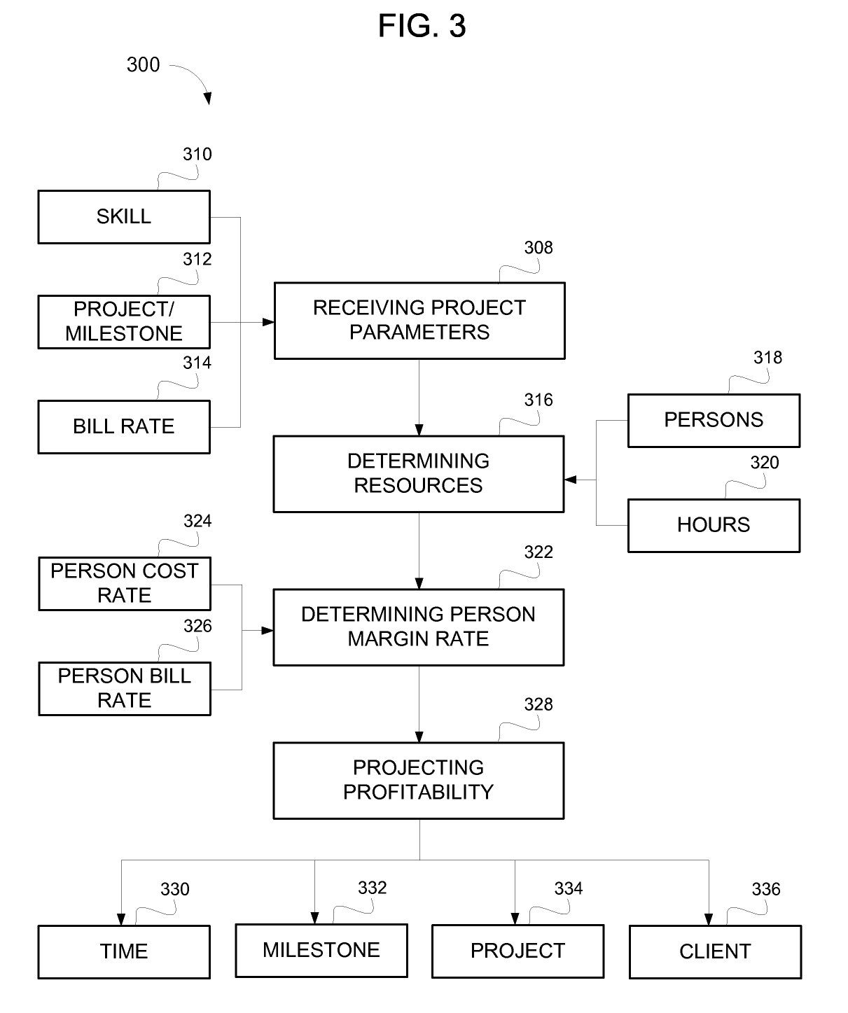

FIG. 3 is a method block diagram, in accordance with an embodiment of the invention. In some embodiments, method 300 may be implemented by the one or more profitability projection components 116. In some embodiments, method 300 may include receiving one or more project parameters at 308, determining one or more resources at 316, determining one or more person margin rates at 322, and/or projecting profitability at 328. In some embodiments, the receiving one or more project parameters at 308 may include receiving one or more skills at 310, receiving one or more projects and/or milestones at 312, and/or receiving one or more bill rates at 314. In some embodiments, the determining resources at 316 may include determining one or more persons at 318 and/or determining one or more hours at 320. In some embodiments, the projecting profitability at 328 may include projecting profitability for one or more times at 330, projecting profitability for one or more milestones at 332, projecting profitability for one or more projects at 334, and/or projecting profitability for one or more clients at 336. As described further below, method 300 provides for precise profitability projections based upon margin rates that are determined based upon specific present and future work parameters.

In some embodiments, method 300 may include projecting profitability of the at least one person using project parameters received via user input, the received project parameters usable to determine the margin rate of the at least one person using the margin rate component. For example, in some embodiments, method 300 may include receiving project parameters of a C++ programmer for 100 hours at $150/hr at 308, determining a C++ programmer available for 100 hours at 316, determining a margin rate for the programmer at a $150/hr bill rate using method 200 at 322, and projecting profitability of the programmer such by multiplying the margin rate by 100 hours at 328.

In some embodiments, method 300 may include a calendaring component configured to identify the at least one person using the received project parameters based upon ability or availability. For example, in some embodiments, the calendaring component 128 is configured to Alterably identify the at least one person using the received project parameters based upon ability or availability. The calendaring component 128 may track person ability and/or availability based upon defined skills and/or existing obligations, personal vacation, and/or holidays. For example, the calendaring component 128 may track that a C++ programmer is available during normal business work days during July 2009 with the exception of July 3^{rd} and July 4^{th} when the programmer has a scheduled vacation. Thus, method 300 may include receiving project parameters of a C++ programmer for 16 hours at $150/hr between Jul. 1, 2009 and Jul. 10, 2009 at 308, determining that the C++ programmer is available for 16 hours using the calendaring component 128 at 316 (and optionally scheduling the programmer in the calendaring component 128), determining a margin rate for the programmer at a $150/hr bill rate using method 200 at 322, and projecting profitability of the programmer such as by multiplying the margin rate by 16 hours at 328.

In some embodiments, method 300 may include wherein the received project parameters comprise the bill rate, the at least one person, and the quantity of hours. For example, in some embodiments, method 300 may include receiving project parameters of a particular programmer at a specified bill rate of $250/hr for 25 hours at 316, determining a margin rate for the particular programmer at a $250/hr bill rate using method 200 at 322, and/or projecting profitability of the particular programmer such as by multiplying the margin rate by 25 hours at 328.

In some embodiments, method 300 may include wherein the at least one person is derived from at least one specified skill and/or the quantity of hours is derived from at least one milestone or project. For example, in some embodiments, method 300 may include receiving a specified skill of a database developer for a project expected to require 3 days of effort and deriving project parameters of a particular programmer at a rate of $250/hr for 25 hours at 316, determining a margin rate for the particular programmer at a $250/hr bill rate using method 200 at 322, and/or projecting profitability of the particular programmer such as by multiplying the margin rate by 25 hours at 328.

In some embodiments, method 300 may include wherein the at least one person is a generic person or an actual person. In some embodiments, a generic person is based on an actual person or one or more average actual persons and is usable as a straw-person for projecting profitability or determining needs, such as when it is uncertain whether an actual person will be available. For example, in some embodiments, method 300 may include receiving project parameters of a C++ programmer for 100 hours at $150/hr at 308, determining a generic C++ programmer at 316, determining a margin rate for the generic programmer at a $150/hr bill rate using method 200 at 322, and projecting profitability of the generic programmer such as by multiplying the margin rate by 100 hours at 328.

In some embodiments, method 300 may include projecting profitability of the at least one person for at least one time period, at least one milestone, at least one project, or at least one client. For example, in some embodiments, method 300 may include receiving project parameters of a project manager for 100 hours at $150/hr and at 308, determining a project manager available for 100 hours at 316, determining a margin rate for the project manager at a $150/hr bill rate using method 200 at 322, and projecting profitability of the project manager at 328. In some embodiments, the projecting profitability of the project manager at 328 may include projecting profitability for a time period by multiplying the margin rate of the project manager by the time, such as by a week, month, year, or other time period. In some embodiments, the projecting profitability of the project manager at 328 may include projecting profitability for a milestone by multiplying the margin rate of the project manager by the milestone of a project time. In some embodiments, the projecting profitability of the project manager at 328 may include projecting profitability for a project by multiplying the margin rate of the project manager by project time. In some embodiments, the projecting profitability of the project manager at 328 may include projecting profitability for a client by multiplying the margin rate of the project manager by the total client time such as for multiple projects.

In some embodiments, method 300 may include projecting profitability of a plurality of persons using the project parameters received via user input, the received project parameters usable to determine corresponding margin rates for each of the plurality of persons using the margin rate component, wherein the profitability of each of the plurality of persons may differ according to corresponding bill rates and cost rates for each of the plurality of persons. For example, in some embodiments, method 300 may include receiving project parameters of a C++ programmer for 100 hours at $150/hr, a SQL developer for 50 hours at $175/hr, and a graphic designer for 25 hours at $75/hr at 308, determining a C++ programmer available for 100 hours, a SQL developer available for 50 hours, and a graphic designer available for 25 hours at 316, determining a margin rate for the programmer at a $150/hr bill rate, a margin rate for the developer at a $175/hr bill rate, and a margin rate for the graphic designer at a $75/hr bill rate using method 200 at 322, and projecting profitability of the programmer, the developer, and the graphic designer such as by multiplying the programmer margin rate by 100 hours, multiplying the developer margin rate by 50 hours, and the graphic designer margin rate by 25 hours at 328. In some embodiments, profitability may be projected for a plurality of persons based upon persons that may have different bill rates, different cost rates, different margin rates, different start dates, different end dates, different hours, and/or different vacation or holidays.

In some embodiments, method 300 may include projecting profitability of the plurality of persons for at least one time period, at least one milestone, at least one project, or at least one client. For example, in some embodiments, method 300 may include receiving project parameters of a C++ programmer for 100 hours at $150/hr, a SQL developer for 50 hours at $175/hr, and a graphic designer for 25 hours at $75/hr at 308, determining a C++ programmer available for 100 hours, a SQL developer available for 50 hours, and a graphic designer available for 25 hours at 316, determining a margin rate for the programmer at a $150/hr bill rate, a margin rate for the developer at a $175/hr bill rate, and a margin rate for the graphic designer at a $75/hr bill rate using method 200 at 322, and projecting profitability of the programmer, the developer, and the graphic at 328. In some embodiments, the projecting profitability of the programmer, the developer, and the graphic designer at 328 may include projecting profitability for a time period by multiplying and then summing the margin rates of the programmer, the developer, and/or the graphic designer by their respective time within a given period. In some embodiments, the projecting profitability of the programmer, the developer, and the graphic designer at 328 may include projecting profitability for a milestone by multiplying and then summing the margin rates of the programmer, the developer, and/or the graphic designer by for their respective time within a given milestone period. In some embodiments, the projecting profitability of the programmer, the developer, and the graphic designer at 328 may include projecting profitability for a project by multiplying and then summing the margin rates of the programmer, the developer, and/or the graphic designer by their respective time within a given project. In some embodiments, the projecting profitability of the programmer, the developer, and the graphic designer at 328 may include projecting profitability for a client by multiplying and then summing the margin rates of the programmer, the developer, and/or the graphic designer by their respective time for a given client. In some embodiments, the projecting profitability includes projecting how profitability is affected at any level based upon the current profitability projections (e.g. client profitability may go down only a small fraction because of other more profitable work despite a significant loss on a current project).

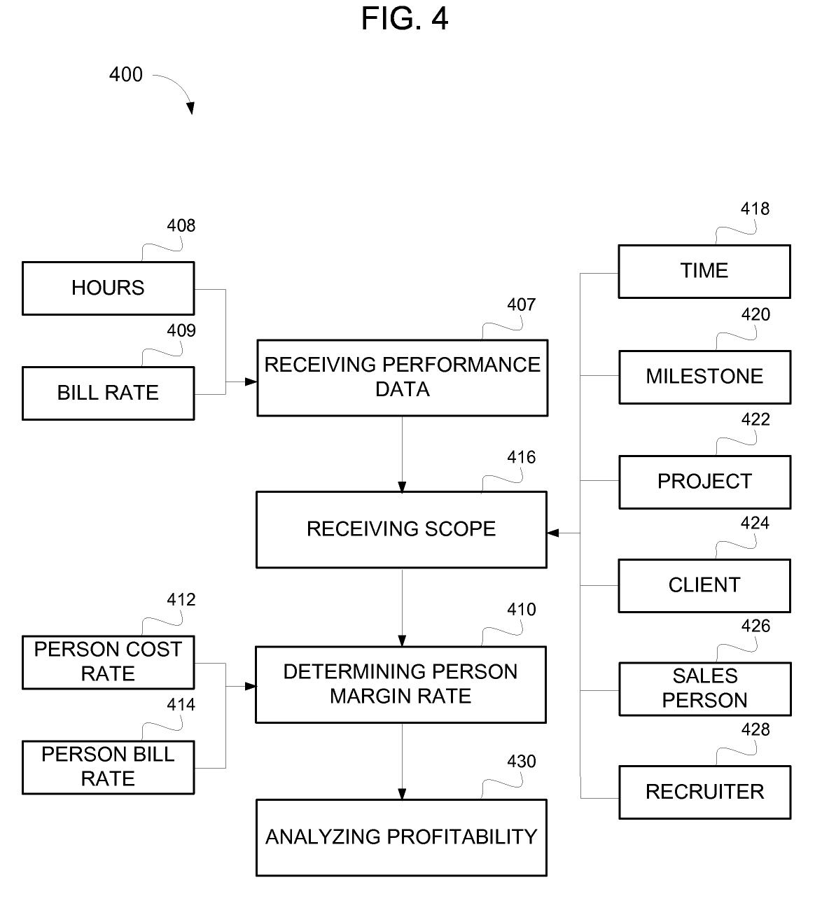

FIG. 4 is a method block diagram, in accordance with an embodiment of the invention. In some embodiments, method 400 may be implemented by one or more profitability analyzer components 120. In some embodiments, method 400 may include receiving one or more performance data at 407, receiving one or more scopes at 416, determining one or more person margin rates at 410, and/or analyzing profitability at 430. In some embodiments, the receiving one or more performance data at 407 may include receiving one or more hours at 408 and/or receiving one or more bill rates at 409. In some embodiments, the receiving one or more scopes at 416 may include receiving one or more times at 418, receiving one or more milestones at 420, receiving one or more projects at 422, receiving one or more clients at 424, receiving one or more sales persons at 426, and/or receiving one or more recruiters at 426. In some embodiments, the determining one or more person margin rates at 410 may include determining one or more person cost rates at 412 and/or determining one or more person bill rates at 414. As described further below, method 400 provides for precise profitability determinations based upon margin rates that are determined for specific present and past performed work.

In some embodiments, method 400 may include analyzing profitability of the at least one person using performance data received from a data source, the received performance data usable to determine the margin rate of the at least one person using the margin rate component. For example, in some embodiments, method 400 may include receiving performance data of a C++ programmer of 100 hours worked at a bill rate of $150 at 407, determining the C++ programmer's margin rate at the $150 bill rate using method 200 at 410, and analyzing profitability by multiplying the margin rate by the 100 hours at 430.

In some embodiments, method 400 may include wherein the received performance data comprise the bill rate, the at least one person, and the quantity of hours. For example, in some embodiments, method 400 may include receiving an identity of a graphic designer, a bill rate of $100 for 50 hours, a bill rate of $75 for 150 hours, and a bill rate of $95 for 200 hours at 407. For example, in some embodiments, method 400 may include receiving an identity of a programmer, a bill rate of $200 for 25 hours and a bill rate of $175 for 50 hours at 407.

In some embodiments, method 400 may include analyzing profitability of the at least one person for at least one time period, at least one milestone, at least one project, or at least one client. For example, method 400 may include receiving an identity of a graphic designer, a bill rate of $100 for 50 hours, a bill rate of $75 for 150 hours, and a bill rate of $95 for 200 hours at 407, receiving a time period of work performed for the week of Jul. 7, 2008 through Jul. 14, 2008 at 416, determining margin rates for the graphic designer for hours worked within that week at the respective bill rates using method 200 at 410, and analyzing the profitability of the graphic designer for the week by multiplying and then summing the margin rates by the respective hours at 430.

In some embodiments, method 400 may include analyzing profitability of a plurality of persons using the performance data received from the data source, the received performance data usable to determine corresponding margin rates for each of the plurality of persons using the margin rate component, wherein the profitability of each of the plurality of persons may differ according to corresponding bill rates and cost rates for each of the plurality of persons. For example, in some embodiments, method 400 may include receiving performance data of a C++ programmer of 100 hours worked at a bill rate of $150, a consultant of 50 hours worked at a bill rate of $125, and a SQL developer of 75 hours worked at a bill rate of $175 at 407, determining the C++ programmer's margin rate at the $150 bill rate, the consultant's margin rate at the $125 bill rate, and the developer's margin rate at the $175 bill rate using method 200 at 410, and analyzing profitability by multiplying and then summing the respective margin rates by the respective hours at 430. In some embodiments, profitability may be analyzed for a plurality of persons based upon persons that may have different bill rates, different cost rates, different margin rates, different start dates, different end dates, different hours, and/or different vacation or holidays.

In some embodiments, method 400 may include analyzing profitability of the plurality of persons for at least one time period, at least one milestone, at least one project, or at least one client. For example, method 400 may include receiving an identity of a graphic designer having a bill rate of $100 for 50 hours, a bill rate of $75 for 150 hours, and a bill rate of $95 for 200 hours at 407, receiving an identity of a programmer having a bill rate of $175 for 25 hours, a bill rate of $125 for 75 hours, and a bill rate of $135 for 30 hours at 407, receiving a time period of work performed for the week of Jul. 7, 2008 through Jul. 14, 2008 at 416, determining margin rates for the graphic designer and programmer for hours worked within that week at the respective bill rates using method 200 at 410, and analyzing the profitability of the graphic designer and programmer for the week by multiplying and then summing the margin rates by the respective hours at 430. In some embodiments, profitability may be analyzed for one or more persons involved in a milestone of a project, a project, or a client. In some embodiments, profitability may be analyzed for a sales person based upon one or more persons involved in work performed for a client for whom the sales person was responsible for securing. In some embodiments, profitability may be analyzed for a recruiter based upon work performed by one or more persons for whom the recruiter was responsible for securing.

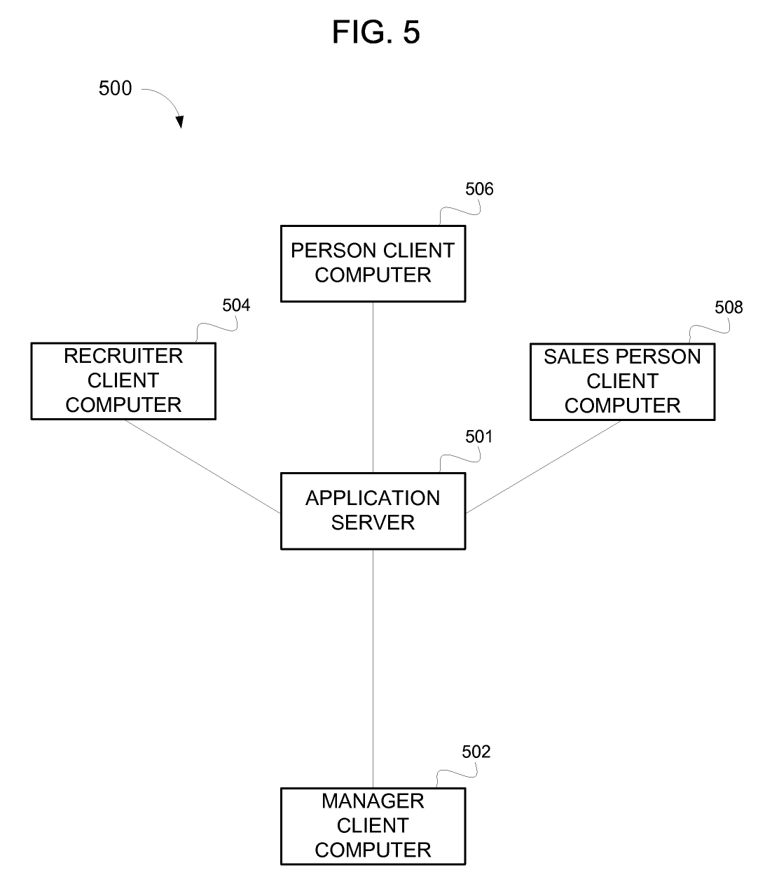

FIG. 5 is a system diagram, in accordance with an embodiment of the invention. In some embodiments, system 500 may include an application server 501, a recruiter client computer 504, a person client computer 506, a sales person client computer 508, and/or a manager client computer 502. In some embodiments, the application server 501 implements the profitability component 112, the time keeper component 122, the invoicing component 124, the case flow component 126, the calendaring component 128, and/or the opportunity tracking component 130. The application server 501 may be a single computer or a distributed computer system and may be accessible to the recruiter client computer 504, the person client computer 506, the sales person client computer 508, and/or the manager client computer 502 via electronic or wireless communication. Subject to any defined security parameters, a sales person who secures clients, a recruiter who secures persons, a person who performs work, and/or a manager who oversees work may access the application server 501 to provide and receive data for profitability projections, profitability analysis, time keeping functions, invoicing functions, cash flow functions, calendaring functions, and/or opportunity tracking functions. For example, a sales person discussing a prospective project with a client can determine profitability for the prospective project in real time.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A system comprising:
an application server, the application server comprising a profitability component.

2. The system of claim 1, wherein the profitability component comprises a margin rate component configured to performing the steps comprising:
determining a margin rate of at least one person using a bill rate for the at least one person and a cost rate for the at least one person, the cost rate for the at least one person being a function of a quantity of hours and/or the bill rate.

3. The system of claim 2, wherein the cost rate for the at least one person is determined by receiving a pay rate for the at least one person and at least one overhead for the at least one person and the quantity of hours, wherein the pay rate for the at least one person or the at least one overhead for the at least one person is a function of the quantity of hours and/or the bill rate.

4. The system of claim 3, wherein the pay rate for the at least one person and the at least one overhead for the at least one person are received from an administrative component.

5. The system of claim 3, wherein the at least one overhead for the at least one person comprises at least one non-commission, at least one sales commission, or at least one recruiter commission.

6. The system of claim 3, wherein the at least one overhead for the at least one person is selected from a plurality of overheads according to the at least one person.

7. The system of claim 3, wherein the at least one overhead for the at least one person is fixed, variable, a multiplier, or incremental.

8. The system of claim 3, wherein the profitability component further comprises a profitability projection component configured to performing the steps comprising:
projecting profitability of the at least one person using project parameters received via user input, the received project parameters usable to determine the margin rate of the at least one person using the margin rate component.

9. The system of claim 8, wherein the application server comprises:
a calendaring component, the calendaring component configured to identify the at least one person using the received project parameters based upon ability or availability.

10. The system of claim 8, wherein the received project parameters comprise the bill rate, the at least one person, and the quantity of hours.

11. The system of claim 10, wherein the at least one person is derived from at least one specified skill and/or the quantity of hours is derived from at least one milestone or project.

12. The system of claim 10 wherein the at least one person is a generic person or an actual person.

13. The system of claim 10, wherein the profitability projection component is configured to performing the steps comprising:
projecting profitability of the at least one person for at least one time period, at least one milestone, at least one project, or at least one client.

14. The system of claim 10, where the profitability projection component is configured to performing the steps comprising:
projecting profitability of a plurality of persons using the project parameters received via user input, the received project parameters usable to determine corresponding margin rates for each of the plurality of persons using the margin rate component, wherein the profitability of each of the plurality of persons may differ according to corresponding bill rates and cost rates for each of the plurality of persons.

15. The system of claim 14, wherein the profitability projection component is configured to performing the steps comprising:
projecting profitability of the plurality of persons for at least one time period, at least one milestone, at least one project, or at least one client.

16. The system of claim 3, wherein the profitability component further comprises a profitability analyzer component configured to performing the steps comprising:
analyzing profitability of the at least one person using performance data received from a data source, the received performance data usable to determine the margin rate of the at least one person using the margin rate component.

17. The system of claim 16, wherein the received performance data comprise the bill rate, the at least one person, and the quantity of hours.

18. The system of claim 17, wherein the profitability analyzer component is configured to performing the steps comprising:
analyzing profitability of the at least one person for at least one time period, at least one milestone, at least one project, or at least one client.

19. The system of claim 17, wherein the profitability analyzer component is configured to performing the steps comprising:
analyzing profitability of a plurality of persons using the performance data received from the data source, the received performance data usable to determine corresponding margin rates for each of the plurality of persons using the margin rate component, wherein the profitability of each of the plurality of persons may differ according to corresponding bill rates and cost rates for each of the plurality of persons.

20. The system of claim 19, wherein the profitability analyzer component is configured to performing the steps comprising:
analyzing profitability of the plurality of persons for at least one time period, at least one milestone, at least one project, or at least one client.
